(19) United States
(12) Patent Application Publication
(10) Pub. No.: US 2026/0056276 A1
(43) Pub. Date: Feb. 26, 2026

(54) SYSTEMS AND METHODS FOR ACOUSTIC BEAMFORMING WITH STRUCTURAL SENSORS

(71) Applicant: UNIVERSITY OF ROCHESTER, Rochester, NY (US)

(72) Inventors: Michael C. Heilemann, West Henrietta, NY (US); Mark F. BOCKO, Caledonia, NY (US); Joseph Dipassio III, Clarkston, MI (US); Jenna Rutowski, Alden, NY (US); Benjamin Thompson, Rochester, NY (US)

(73) Assignee: UNIVERSITY OF ROCHESTER, Rochester, NY (US)

(21) Appl. No.: 19/226,766

(22) Filed: Jun. 3, 2025

Related U.S. Application Data
(60) Provisional application No. 63/656,839, filed on Jun. 6, 2024.

(51) Int. Cl. G01S 3/801

(52) U.S. Cl. CPC G01S 3/801

(57) ABSTRACT

A method and system of detecting sound by acoustic beamforming with structural sensors wherein an array of sound sensors placed on an elastic base surface can pick up vibrations caused by incoming acoustic waves and acoustic beamforming enables highly sensitive directional listening. In some embodiments, only a single sensor is used affixed to an elastic base surface and the remaining sound reception may be constructed using virtual sensors that are created by extrapolation from the sound received by the single sensor.

### RELATED APPLICATIONS

This application claims priority to U.S. Provisional Patent Application Ser. No. 63/656,839, filed on Jun. 6, 2024, the contents of which are expressly incorporated by reference.

This invention was made with government support under grant number 2104758 awarded by the National Science Foundation. The government has certain rights in the invention.

### FIELD

This application relates to the field of acoustic beamforming, in particular, the sensing of sound directionally, and the enhancement of sound detected.

### BACKGROUND

Acoustic beamforming is a process of combining signals from multiple sensing elements to create a directionally dependent sensor. In many use cases, the sensing elements are configured to focus the beam toward a particular direction so that sound sources incident from that direction are enhanced while sound sources incident from other directions are diminished. However, the sensing elements may be configured to create any number of directivity patterns. Acoustic beamforming is used for a number of applications such as signal enhancement, noise reduction, and source localization/tracking.

### SUMMARY

One aspect of the present application relates to method of detecting sound by acoustic beamforming with structural sensors, comprising the steps of: affixing one or more structural vibration or strain sensing elements to an elastic base surface, wherein bending vibrations of the elastic base surface are excited by incoming acoustic waves and the one or more structural vibration or strain sensing elements in turn output a signal corresponding to the motion of the base surface at the sensor location due to acoustic wave excitation; determining a response of one or more structural vibration or strain sensing elements individually to acoustic waves at varying angles of incidence wherein the responses are obtained at frequencies within the audio bandwidth; selecting a target polar pattern for the sensor array at each frequency, wherein the polar pattern governs the sensitivity of the signal recorded by the one or more structural vibration or strain sensing elements to waves depending on their angles of incidence, and wherein the amplitude of the signals combined from all sensors, or a subset of sensors, is highest to waves incident at a desired angle of incidence, and minimized at all other angles; computing a filter to be applied to each one or more structural vibration or strain sensing element signal or virtual one or more structural vibration or strain sensing element signal, wherein the filter governs the magnitude and phase of each signal; generating coefficients for each filter such that the difference between the target polar pattern and the polar pattern generated by combining each filtered sensor signal is minimized; receiving a beamformed audio signal from the one or more structural vibration or strain sensing elements by summing the filtered signals recorded by each vibration of one or more structural vibration or strain sensing elements or inferred via one or more virtual structural vibration or strain sensing elements.

Another aspect of the application is a system of detecting sound by acoustic beamforming with structural sensors, comprising: an elastic base surface; one or more structural vibration or strain sensing elements affixed to the elastic base surface, wherein bending vibrations of the elastic base surface are excited by incoming acoustic waves and the one or more structural vibration or strain sensing elements in turn output a signal corresponding to the motion of the base surface at the sensor location due to acoustic wave excitation; a processor and a memory having instructions stored thereon, wherein execution of the instructions by the processor computes a filter to be applied to each one or more structural vibration or strain sensing element signal or virtual one or more structural vibration or strain sensing element signal, wherein the filter governs the magnitude and phase of each signal; a receiver, wherein a beamformed audio signal is received from the one or more structural vibration or strain sensing elements by summing the filtered signals recorded by each vibration one or more structural vibration or strain sensing element or inferred via one or more virtual structural vibration or strain sensing elements, wherein the beamformed audio signal has been determined according to the method described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present application can be better understood by reference to the following drawings, wherein like references numerals represent like elements. The drawings are merely exemplary to illustrate certain features that may be used singularly or in combination with other features and the present disclosure should not be limited to the embodiments shown.

FIG. 1 shows a panel with N sensors sₙ excited by an acoustic source signal X(ω) incident at azimuthal angle θ. The sensor output Yₙ (θ, ω) is given by multiplying by the transfer function Gₙ (θ, ω). Note that the elevation angle ϕ given in (1) is omitted assuming the source shown in this figure is in the azimuthal plane only.

FIG. 2 shows directivity of panel beamformers with 1, 3, and 5 sensors and a 5-sensor ULA. The directivity is shown for target steering angles of 0° and 40° as labeled in the legend.

FIG. 3 shows measured frequency polar pattern for a 5-sensor panel beam-former steered toward a target angle of 40°. The response is given in dB relative to the highest signal level.

FIG. 4 shows measured polar pattern at 1500 Hz with a target angle of 40° using 1, 3, and 5-sensor panel beamformers, and a 5-sensor ULA.

FIG. 5 shows measured polar pattern for a 5-sensor panel beamformer steered toward a target angle of −30° in the elevation plane. The response is given in dB relative to the highest signal level.

FIG. 6A shows a panel with structural sensor array in a whisper room. A loudspeaker was placed 1 m away in the azimuthal plane and the panel was placed on a turntable so that the impulse response at each sensor location could be measured with 5° resolution in front of the panel. FIG. 6B shows a panel with a single structural sensor in a Whisper Room. A loudspeaker was placed 1 m away in the azimuthal plane and the panel was placed on a turntable so that the impulse response at each sensor location could be measured in 5° increments in front of the panel. The configuration of the sensor array on the panel is depicted in the inset of the figure.

FIG. 7 shows location of virtual sensors used in this experiment. These virtual sensors were used in conjunction with the real sensor affixed to the panel seen in FIGS. 6A & 6B.

FIG. 8 shows polar plot versus frequency of individual unfiltered sensor signals and the sum of the unfiltered sensor signals. (a) corresponds to the polar plot versus frequency of sensor 1, (b) corresponds to the polar plot versus frequency of virtual sensor 1, and (c) corresponds to the polar plot versus frequency of virtual sensor 2. (d) corresponds to the polar response of the combined output of all sensors. Plots for virtual sensors 4 and 5 are not shown as they are symmetric with recorded sensor 1 and virtual sensor 1, respectively. Normalization was done such that the highest signal level recorded corresponds to 0 dB.

FIG. 9 shows polar plot versus frequency of the beamformer utilizing signals recorded by a single vibration sensor. The recorded signal is used to infer the signal recorded by four other sensors on the panel. These real and inferred signals are then filtered to create a target polar pattern at −50° in (a), 0° in (b), −20° in (c), and 40° in (d). Normalization was again performed such that the highest signal level recorded corresponds to 0 dB.

FIG. 10 shows measured polar pattern at approximately 1000 Hz with a target angle of 40° using 1, 3, and 5-sensor panel beamformers, and a 5-sensor ULA.

FIG. 11 shows directivity of panel beamformers with 1, 3, and 5 sensors compared to a 5-sensor ULA. Directivity values are plotted for target steering angle of 0°.

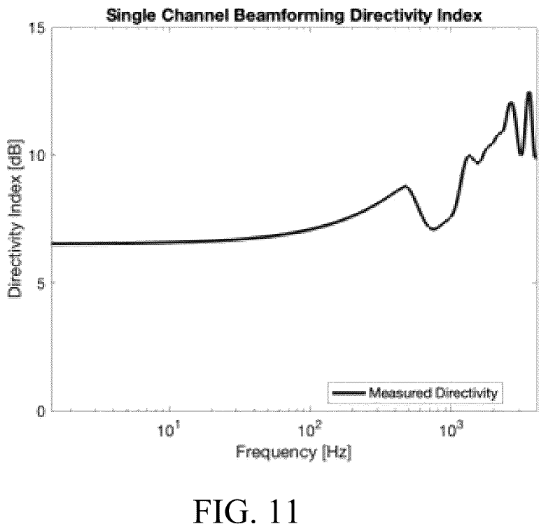

FIG. 12 shows a flow chart for an illustrative embodiment of a system comprising an elastic base surface (121) upon which three structural vibration or strain sensing elements (X; 122) are affixed to form a sensor array; the structural vibration or strain sensing elements (122) are given instruction to apply a filter (126) by a processor (123) with a memory (124) and also send their filtered signals (127) to a receiver (125).

### DETAILED DESCRIPTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting, and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the appended claims, the singular forms “a,” “an” and “the” include plural referents unless the content clearly dictates otherwise.

### Overview

Herein is described a method for acoustic beamforming in which frequency-domain weights are applied to signals recorded by an array of structural sensors coupled to an elastic panel. Experimental results demonstrate that coupling the sensor array to a resonant surface provides the system with spatial information that is not recoverable by probing the acoustic field directly with conventional microphones at the same sensor locations. The fact that the panel response at each frequency is always comprised of a superposition of resonant modes allows the panel beamformer to achieve increased low-frequency directivity, and the flexibility to steer the beam in the elevation plane when compared to a ULA. The use of a panel beamformer as a spatial filter was demonstrated to improve transcription accuracy for speech sources in the presence of babble noise incident from other directions. This is particularly beneficial for smart speakers, which are often tasked with transcribing speech in noisy environments. This technology also has practical uses in areas outside the realm of consumer electronics such as in underwater acoustics, where the ability to construct a fully sealed, directional sensor is a primary design consideration.

Further herein is described a method for beamforming in which frequency-domain weights are applied to the signal from a single structural sensor affixed to an elastic panel. By simulating the responses of additional virtual sensors based on the single recorded signal, this method enables beamforming with surface audio devices, which is not possible using traditional beamforming methods designed for microphone arrays. Experimental results show that the application of beamforming weights results in a substantial improvement in system directionality, with off-axis attenuation of up to 20 dB. This improvement is evident in the recorded polar plots, which illustrate the enhanced directional sensitivity of the system across a broad frequency range and various target angles. Additionally, the beamforming weights significantly improve the intelligibility of target speech signals in the presence of off-axis interfering speech. Analysis demonstrates a significant reduction in WER, indicating that the system can effectively suppress interfering signals and enhance the intelligibility of speech in the target direction, showing an improvement of as much as 191.8% for sources separated by 10° in the azimuthal plane. This is particularly beneficial for applications such as smart speakers, where accurate speech recognition and transcription in noisy environments are crucial for basic operation. This work highlights single-channel approaches as a practical and efficient foundation for advancing surface audio systems, reducing hardware requirements while maintaining high performance in directional audio processing.

### Theory

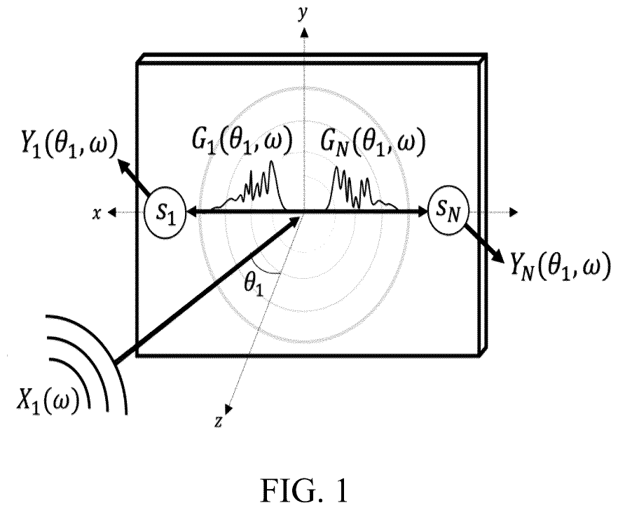

Assume an acoustic source signal x(t) is incident on a panel with N vibration sensors distributed on the surface. The acoustic pressure wave from the source induces bending motion in the panel, and the response Yₙ(θ, ϕ, ω) measured by the n^{th} sensor is given by,

$${Y}_{n} ( θ , ϕ , ω ) = {G}_{n} ( θ , ϕ , ω ) X ( ω ) , \qquad ( 1 )$$

where X (ω) is the frequency-domain representation of x(t) and Gₙ(θ, ϕ, ω) is the transfer function in the frequency domain from the source signal at incident azimuthal (θ) and elevation (ϕ) angles to the location of the n^{th} sensor, as shown in FIG. 1.

Assuming the source is in the far field, such that a plane wave approximation may be used, the relative excitation of each bending mode is dependent on the incident angle of the acoustic pressure wave [L. A. Roussos, “Noise transmission loss of a rectangular plate in an infinite baffle,” NASA Technical Paper, no. 2398, 1985], [B. Wang, C. R. Fuller, and E. K. Dimitriadis, “Active control of noise transmission through rectangular plates using multiple piezoelectric or point force actuators,” J. Acoust. Soc. Am., vol. 90, no. 5, pp. 2820-2830, 1991]. Traditional DAS beamforming methods rely on a uniform frequency response across all sensors and angles to combine signals and create a target polar pattern [M. A. E. Mofeed and H. A. Elsalam Mofeed, “Direction-of-arrival methods (doa) and time difference of arrival (tdoa) position location technique,” in Nat. Radio Sci. Co., 2005]. Affixing sensors at various locations along a panel's surface will cause the magnitude and phase response of each sensor to vary with angle based on the coupling between the senor location and the relative amplitude of each mode at each sensor location [C. Fuller, S. Elliott, and P. Nelson, Eds., Active Control of Vibration. London: Academic Press, 1996]. However, by applying frequency-domain weights to each sensor affixed to the panel, the angular dependency of the panel's vibrational mode excitations can be harnessed to enable beamforming.

A user-defined, directional sensitivity pattern ψ(θ, ϕ) may be achieved by designing a filter Hₙ(ω) for each sensor signal such that the sum of each filtered sensor signal ψ\hat{ }(θ, ϕ, ω) approximates ψ(θ, ϕ), where,

$$\hat{ψ} ( θ , ϕ , ω ) = {{\sum }_{n = 1}}^{N} {Y}_{n} ( θ , ϕ , ω ) {H}_{n} ( ω ) . \qquad ( 2 )$$

The filter for each sensor may be determined by first expressing (1) in matrix form at each frequency ω as,

$$\hat{ψ} = YH , \qquad ( 3 )$$

where the directional sensitivity pattern vector ψ\hat{ } is defined at M discrete angles, and Y is a matrix describing the response of N sensors due to a source at each discrete angle given by,

$$\hat{ψ} = [ \begin{matrix}\hat{ψ} ( {θ}_{1} , {ϕ}_{1} ) \\ ⋮ \\ \hat{ψ} ( {θ}_{M} , {ϕ}_{M} )\end{matrix} ] , Y ( ω ) = [ \begin{matrix}{Y}_{1} ( {θ}_{1} , {ϕ}_{1} ) & … & {Y}_{N} ( {θ}_{1} , {ϕ}_{1} ) \\ ⋮ & ⋱ & ⋮ \\ {Y}_{1} ( {θ}_{M} , {ϕ}_{M} ) & … & {Y}_{N} ( {θ}_{M} , {ϕ}_{M} )\end{matrix} ] . \qquad ( 4 )$$

The filter weights H required to achieve a target directional sensitivity at each frequency may be determined by replacing ψ\hat{ } given in (3) with a vector ψ specifying the target directional sensitivity and applying the pseudo-inverse of the sensor response matrix Y⁺ as,

$$H = {Y}^{+} ψ . \qquad ( 5 )$$

To obtain the pseudo-inverse of the non-square matrix Y, Singular Value Decomposition (SVD) may be performed, as demonstrated in inverse filtering applications [M. Tanter, J.-L. Thomas, and M. Fink, “Time reversal and the inverse filter,” J. Acoust. Soc. Am., vol. 108, no. 1, pp. 223-234, 07 2000.], [D. Tufts and R. Kumaresan, “Singular value decomposition and improved frequency estimation using linear prediction,” Acoustics, Speech and Signal Processing, IEEE Transactions on, vol. 30, pp. 671-675, 09 1982]. The frequency-domain weights given in H may then be applied directly to the frequency domain representation of the received sensor signals or converted into finite impulse response (FIR) filters by taking the inverse discrete Fourier transform (DFT).

### Filter Methods

The filtering process aims to minimize the difference between the simulated and target polar patterns to generate filter coefficients for each of the sensors affixed to the panel in order to maximize the combined signal for all sensors at a particular angle.

In a preferred, but non-limiting, embodiment, singular value decomposition as described herein is performed. Unless otherwise specified, the term singular value decomposition encompasses all the herein described variations and equivalent computational methods known in the art, including, but not limited to, full SVD, reduced (or compact) SVD, truncated SVD, randomized SVD, or incremental SVD.

In other embodiments, following data initialization and sensor setup, an optimization method is implemented to iteratively refine filter coefficients for achieving a target polar pattern. Optimization methods may include, but are not limited to, interior-point, particle swarm, and pattern search. Parameters are tuned to ensure convergence to an optimal solution while balancing computational efficiency with solution accuracy. The optimized filter coefficients are then applied to the sensor array, facilitating real-time beamforming that aligns sensor contributions to achieve the target polar pattern. Polar plots derived from the recorded audio data demonstrate the efficacy of this approach.

The target polar pattern defines what the amplitude of the combined sensor signals should be for waves incident at different angles. The target polar pattern can be used to make the microphone have any directivity a user wants. In one instance, the target polar pattern can be a beam, where it is sensitive in one direction vs. others. In another instance, the target polar pattern can be omnidirectional, where it picks up sound from everywhere equally. Filters are applied to the sensor signals so that when the filtered sensor signals are summed, the amplitude of that summation has a directional dependance governed by the target (or as close as obtainable to the target given the number and spacing of the sensors).

In some embodiments, acoustic beamforming can be done using a single structural sensor (as long as a priori measurements of the angular-dependent transfer function are made between an acoustic source and the surface vibration profile). In such instances, “virtual sensor” signals are inferred from single sensor measurements. Depending on how many virtual sensors are created, one can eliminate, or at least reduce spatial aliasing effects at high frequency.

### Method of Detecting Sound by Acoustic Beamforming

An aspect of the application is a method of detecting sound by acoustic beamforming with structural sensors, comprising the steps of: affixing one or more structural vibration or strain sensing elements to an elastic base surface, wherein bending vibrations of the elastic base surface are excited by incoming acoustic waves and the one or more structural vibration or strain sensing elements in turn output a signal corresponding to the motion of the base surface at the sensor location due to acoustic wave excitation; determining a response of one or more structural vibration or strain sensing elements individually to acoustic waves at varying angles of incidence wherein the responses are obtained at frequencies within the audio bandwidth; selecting a target polar pattern for the sensor array at each frequency, wherein the polar pattern governs the sensitivity of the signal recorded by the one or more structural vibration or strain sensing elements to waves depending on their angles of incidence, and wherein the amplitude of the signals combined from all sensors, or a subset of sensors, is highest to waves incident at a desired angle of incidence, and minimized at all other angles; computing a filter to be applied to each one or more structural vibration or strain sensing element signal and/or one or more virtual structural vibration or strain sensing element signal, wherein the filter governs the magnitude and phase of each signal; generating coefficients for each filter such that the difference between the target polar pattern and the polar pattern generated by combining each filtered sensor signal is minimized; and receiving a beamformed audio signal from the one or more structural vibration or strain sensing elements by summing the filtered signals recorded by each vibration of one or more structural vibration or strain sensing elements or inferred via one or more virtual structural vibration or strain sensing elements.

In particular embodiments, the minimizing technique is singular value decomposition (SVD) (see theory section discussion of SVD). One of ordinary skill will understand that the use of a particular technique for generating coefficients for each filter, such that the difference between the target polar pattern and the polar pattern generated by combining each filtered sensor signal is minimized, is not limiting on the methods described herein.

The use of SVD in generating the filter coefficients facilitates accurate beam pattern synthesis by systematically capturing the spatial transfer characteristics of the sensor array and enabling a numerically stable and optimal solution to the inverse beamforming problem. It should be noted that the polar pattern produced by SVD (or other techniques) is not a simulated polar pattern, but the real polar pattern that would result from combining the filtered responses.

Another aspect of the application is a method of detecting sound by acoustic beamforming with structural sensors, comprising the steps of: affixing one or more structural vibration or strain sensing elements to an elastic base surface; determining a response of one or more structural vibration or strain sensing elements individually to acoustic waves at varying angles of incidence wherein the responses are obtained at frequencies within the audio bandwidth; selecting a target polar pattern for the sensor array at each frequency; computing a filter to be applied to each one or more structural vibration or strain sensing element signal or virtual one or more structural vibration or strain sensing element signal, wherein the filter governs the magnitude and phase of each signal; and receiving a beamformed audio signal from the one or more structural vibration or strain sensing elements by summing the filtered signals recorded by each vibration of one or more structural vibration or strain sensing elements or inferred via one or more virtual structural vibration or strain sensing elements.

Bending vibrations of the elastic base surface are excited by incoming acoustic waves and the one or more structural vibration or strain sensing elements in turn output a signal corresponding to the motion of the base surface at the sensor location due to acoustic wave excitation.

The polar pattern governs the sensitivity of the signal recorded by the one or more structural vibration or strain sensing elements to waves depending on their angles of incidence. The amplitude of the signals combined from all sensors, or a subset of sensors, is highest to waves incident at a desired angle of incidence, and minimized at all other angles

In some embodiments, optimizing each filter such that the sum of the filtered signals best approximates the target polar pattern.

In some embodiments, the one or more structural vibration or strain sensing elements are vibration sensors.

In some embodiments, the one or more structural vibration or strain sensing elements are strain sensors.

In some embodiments, the individual responses of the one or more structural vibration or strain sensing elements is determined by empirical measurements.

In some embodiments, the individual responses of the one or more structural vibration or strain sensing elements is inferred as a “virtual sensor” from a single sensor signal using a priori measurements of the system transfer functions.

In some embodiments, the individual responses of the one or more structural vibration or strain sensing elements is determined using an analytical model.

In some embodiments, the analytical model is selected from the group comprising FEM, lumped element, equivalent circuit models, generic differential equation system solver, artificial intelligence-generated model, and deep neural network.

In some embodiments, the optimization minimizes the mean-square error or other perceptually weighted error metrics between the target polar pattern and the polar pattern reconstructed by summing the filtered responses received by each sensor or virtual sensor.

In some embodiments, the optimization techniques are one or more global and/or local techniques comprising pattern search, particle swarm, genetic algorithm, or other methods for minimizing an objective function, local schemes with minimization approaches, local schemes with least-squares approaches, and global schemes (GlobalSearch, MultiStart, Surrogate Optimization, Simulated Annealing).

In some embodiments, the structural vibration or strain sensing elements form a sensor array that is distributed on a display screen.

In some embodiments, the structural vibration or strain sensing element signals are read in through a computer.

In some embodiments, the filters can be digital or analog.

In some embodiments, the filter is designed to work within one or more sub-bands of the audio frequency band.

In some embodiments, the one or more of the structural vibration or strain sensing elements are transparent to a visible part of the electromagnetic spectrum.

In some embodiments, the structural vibration or strain sensing elements are located around the perimeter of the panel.

In some embodiments, the structural vibration or strain sensing elements are positioned to couple to a prescribed set of bending modes of the base surface.

In some embodiments, the beamformed signal is used for sound enhancement.

In some embodiments, the beamformed signal is used for source localization/tracking.

### System for Detecting Sound by Acoustic Beamforming

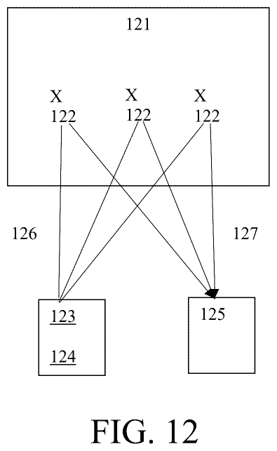

Another aspect of the application is a system of detecting sound by acoustic beamforming with structural sensors, comprising: an elastic base surface (FIG. 12; 121); one or more structural vibration or strain sensing elements (122) affixed to the elastic base surface; a processor (123) and a memory (124) having instructions stored thereon; and a receiver (125).

Bending vibrations of the elastic base surface are excited by incoming acoustic waves and the one or more structural vibration or strain sensing elements in turn output a signal (127) corresponding to the motion of the base surface at the sensor location due to acoustic wave excitation.

Execution of the instructions by the processor computes a filter (126) to be applied to each one or more structural vibration or strain sensing element signal or virtual one or more structural vibration or strain sensing element signal, wherein the filter governs the magnitude and phase of each signal.

In some embodiments, a beamformed audio signal is received from the one or more structural vibration or strain sensing elements by summing the filtered signals recorded by each vibration one or more structural vibration or strain sensing element or inferred via one or more virtual structural vibration or strain sensing elements, wherein the beamformed audio signal has been determined according to the methods described herein.

### Uses

The advantages of using structural sensors for acoustic beamforming include the ability to make the device fully sealed. Electronic devices such as smartphones are susceptible to damage from water and dust through the microphone and loudspeaker ports. Structural sensors can replace these acoustic elements without the need for case penetrations. Furthermore, vibration/strain sensors can be made of inexpensive piezoelectric materials, which reduces costs. In addition, structural sensors can easily be integrated with visual displays.

Uses of the structural sensors described herein include, but are not limited to, such as: smart devices “disguised” in walls, picture frames, or displays; underwater acoustic detector (sonar); interactive displays in tradeshows, transportation hubs, malls, etc. where the user is in a fixed location, but noise interference can come from many directions; open office spaces, where the user is seated, but noise can come from many directions.

Commercially available smart speakers typically utilize multi-microphone arrays for direction-of-arrival (DOA) estimation and acoustic beamforming. For example, the Amazon Echo product line utilizes seven microphones to accomplish these tasks. By employing the methods described above, the manufacturers of such devices could decrease production costs by reducing the number of sensors embedded on their products.

The present application is further illustrated by the following examples that should not be construed as limiting. The contents of all references, patents, and published patent applications cited throughout this application, as well as the figures and Tables, are incorporated herein by reference.

### EXAMPLES

### Example 1: Multiple Sensor Method and System

The effectiveness of using structural vibration sensors for acoustic beamforming was evaluated in three ways. The first evaluation was a quantitative assessment of the directivity of the beam pattern and off-axis attenuation that could be achieved over a given bandwidth. Measurements of the panel beamformer were compared to a simulated ULA beamformer with an identical sensor configuration across varying sensor numbers and beam steering directions.

A second experiment was used to evaluate the ability of the beamformer to effectively spatially filter audio signals incident from different directions. A target speech signal consisting of recordings of smart speaker commands was played at one incident angle, while a separate speech signal consisting of babble speech was simultaneously played at a different incident angle. The system was configured to beamform in the direction of the target speech signal, and the recorded signal was transcribed using IBM Watson's speech-to-text automated speech recognition (ASR) service. The word-error-rate (WER) was computed by comparing the transcribed speech against the transcripts of the actual spoken phrases. The WER metric quantifies the Levenshtein distance between the transcription and the known text quantifying error such as word insertions, deletions, and substitutions as,

$$WER = \frac{Substitutions + Deletions + Insertions}{Total Words in Referemce Text} \times 100 \% , \qquad ( 6 )$$

and was used to evaluate the transcription accuracy of a speech signal the target direction of the spatial filter in the presence of babble speech.

Lastly, the panel beamformer's performance was also measured in the elevation plane to demonstrate its ability to steer a beam in three-dimensional space.

The experimental setup shown in FIG. 1 was used to record the impulse response of each sensor at various angles of acoustic incidence inside a Whisper Room. The panel used in this experiment was a 3 mm thick acrylic panel with Young's Modulus E=3.2 GPa, Poisson's ratio ν=0.35, density ρ=1180 kg m⁻³, and horizontal and vertical dimensions (Lₓ, L_{y})=(36 cm, 26 cm), respectively. The panel was mounted on a rotary table such that the incident angle of the acoustic wave could be measured at M=37 angles in 5° increments spanning angles θ=−90° to θ=+90° in the azimuthal plane in front of the panel.

The panel was equipped with five PCB Piezotronics U352C66 accelerometers evenly spaced in the horizontal dimension and centered in the vertical dimension giving a separation of 6 cm between each sensor. A 3-sensor configuration was derived from the 5 sensor configuration by using the leftmost, middle, and rightmost sensors, and a 1-sensor configuration was derived using the middle sensor only. The response of a ULA was simulated using sensor layouts that matched the configurations used on the panel. A KEF LS50 loudspeaker positioned 1 m in front of the center of the panel was used to reproduce an excitation signal to obtain the impulse response of each sensor at each discrete angle of incidence. The impulse responses of each sensor Gₙ(θ, 0, ω) were recorded at each angle using two, two-second maximum length sequence (MLS) excitations. These recorded impulse responses were used to calculate the beamforming frequency-domain filter coefficients using Eqn. (5), where the target polar pattern was given as a normalized maximum value of 1 at the target angle and a value of 0 at all other angles.

Once the filters were calculated, they were applied to the sensor array and the described experiments were carried out. For these evaluations, a matched pair of KEF LS50 loudspeakers were used to reproduce the dataset of target speech and noise speech.

### Results

The directivity metric, as defined in Kinsler et al. [L. E. Kinsler, A. R. Frey, A. B. Coppens, and J. V. Sanders, Fundamentals of Acoustics, 4th ed. New York: Wiley, 2000], quantifies how efficiently the system concentrates acoustic energy in a specific direction compared to the average across all directions. For this 2D azimuthal analysis, directivity is calculated as the ratio of the squared response at the target angle to the squared responses across all angles at each frequency, assuming the responses in the front and rear of the panel are symmetric. An omnidirectional microphone gives a directivity index of 0 dB since the measured acoustic pressure is the same in all directions. In contrast, directional microphones exhibit higher directivity indices due to their focused sensitivity patterns; for example, a cardioid microphone achieves an average directivity index of approximately 4.8 dB.

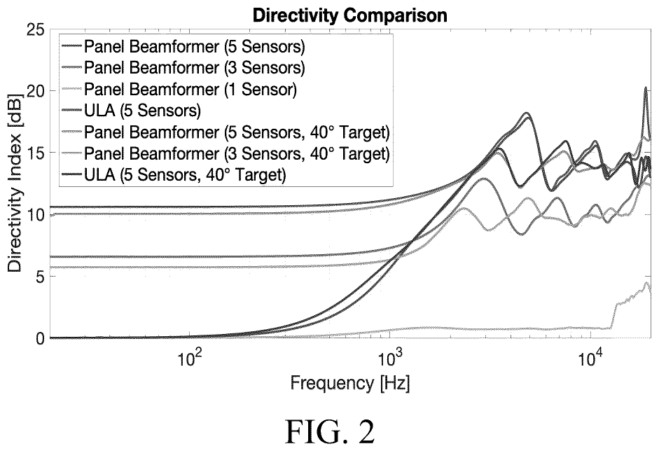

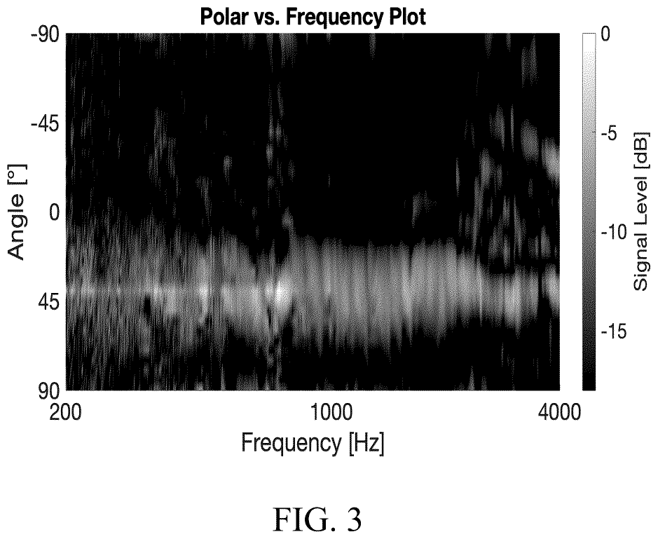

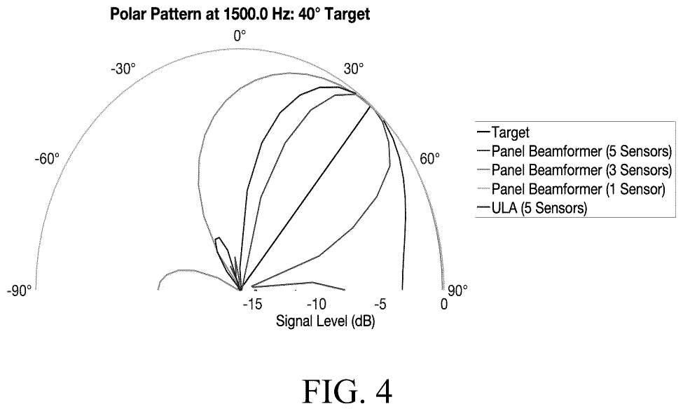

With as few as three sensors, the panel beamformer maintains a directivity above 6 dB across the audible frequency bandwidth, including at low-frequencies where ultrasonic level adaptors (ULAs) are essentially omnidirectional. These characteristics are illustrated in FIG. 2, which shows the directivity vs. frequency for panel beamformers and ULAs across different sensor configurations and beam steering angles. The measured polar directional sensitivity for a 5-sensor panel beamformer, steered toward a target angle of 40° is shown in FIG. 3. The measured polar pattern at 1500 Hz for each sensor configuration steered toward a 40° target is shown in FIG. 4.

The results in Table 1 highlight an improvement in transcription accuracy when the beamformer is used to spatially filter an interfering speech signal. When the target speech originates from −30° and the interfering speech from 30°, the WER is reduced from 134.8% to 24.7% after applying the spatial filter. Similarly, when the target speech is positioned at −10° and the interfering speech at 90°, the WER drops from 123.7% to 16.5%. When the target speech is at 50° and the interfering speech is at 40°, the WER decreases from 306.1% to 43.0%.

TABLE 1
Comparison of WER with and without filters calculated via the inverse
filtering method. Target speech was played from the target angle
with the corresponding frequency-domain weights applied, while
an off-axis babble signal was played at another location.

| Target Speech | Babble | Unfiltered | Filtered |
|---|---|---|---|
| Location | Location | WER (%) | WER (%) |
| −30° | 30° | 134.8 | 24.7 |
| −10° | 90° | 123.7 | 16.5 |
| 50° | 40° | 306.1 | 43 |

| | | |
|---|---|---|
| Baseline (No Babble) | 3.1 | 6.3 |

### Beamforming in the Elevation Plane

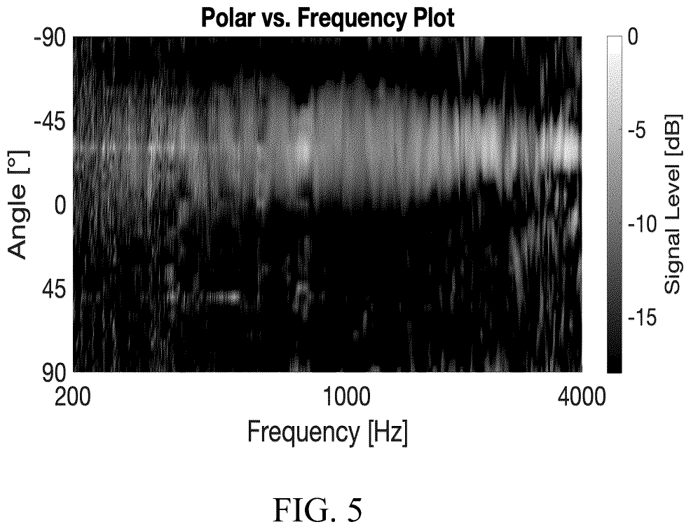

Since the structural sensors record the induced panel response, and not the acoustic field directly, steering of the beam pattern is not necessarily tied directly to the array geometry. A traditional ULA will be omnidirectional in the elevation plane, while a panel microphone allows an additional degree of freedom to beam in both the azimuth and elevation planes as seen in FIG. 5 where a sensor array arranged linearly along the azimuthal plane is configured to steer a beam at −30° in the elevation plane.

### Example 2: Single Sensor Method and System

The effectiveness of using a single structural vibration sensor for acoustic beamforming was evaluated in two ways. The first evaluation was a quantitative assessment of the beam pattern and off-axis attenuation that could be achieved over a given bandwidth for different target angles in front of the panel. This includes both polar plots and the directivity metric, as described by Kinsler above, which evaluates how effectively a system focuses acoustic energy in a given direction relative to the overall average across all directions. In this 2D azimuthal analysis, directivity is determined by taking the ratio of the squared response at the desired angle to the sum of squared responses across all angles at each frequency, under the assumption that the panel exhibits front-back symmetry. An omnidirectional microphone has a directivity index of 0 dB, as it captures sound uniformly from all directions. In contrast, directional microphones achieve higher directivity indices due to their focused sensitivity patterns. For instance, a cardioid microphone typically has an average directivity index of about 4.8 dB. Since the primary application of this system is for speech, the evaluation was limited to the main speech bandwidth, from 100 Hz to 4 kHz.

The second evaluation used an automated speech recognition (ASR) system to transcribe recorded speech signals. A target speech signal was played at one incident angle, while an interfering speech signal was simultaneously played at a different incident angle. The system was configured to beamform in the direction of the target speech signal, and the recorded signal was transcribed using IBM Watson's speech-to-text ASR service. WER scores were computed by comparing the transcribed speech against the transcripts of the actual spoken phrases. The WER metric quantifies the Levenshtein distance between the transcription and the known text and quantifies errors including word insertions, deletions, and substitutions. It is expressed as,

$$WER = \frac{Substitutions + Deletions + Insertions}{Total Words in Referemce Text} \times 100 \% , \qquad ( 6 )$$

and was used to evaluate the effectiveness of the beamformer by comparing the WER percentages for signals recorded with and without the beamforming filters applied.

### Dataset

A single male and a single female participant each recorded 100 sentences containing common phrases used for interaction with smart audio devices. 1 The recordings were conducted in an acoustically treated studio environment using a Shure SM58 microphone at a 48 kHz sample rate. Each sentence began with the wake phrase “Hey, Alexa . . . ,” with variations in pronunciation and intonation to capture natural speech patterns and contextual nuances. This wake phrase was selected for its widespread use, spectral complexity, and rich phonemic structure.

### Setup

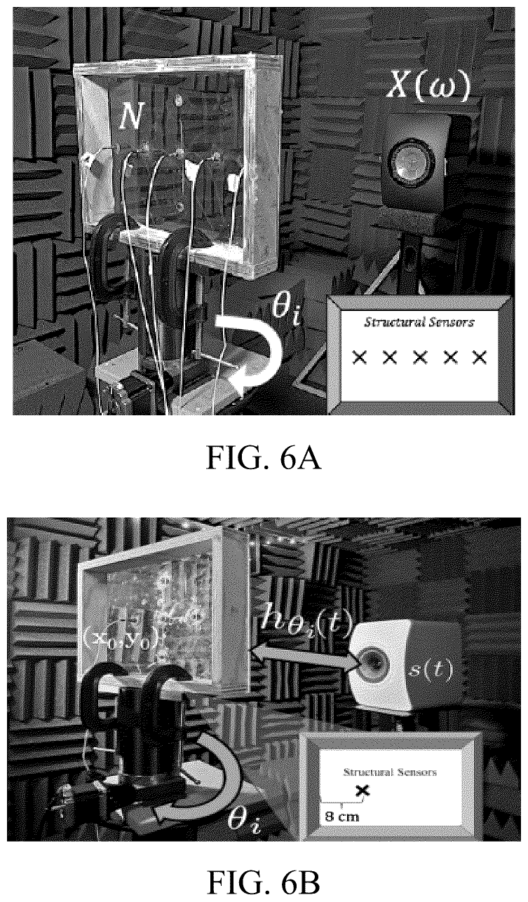

The experimental setup depicted in FIGS. 6A and 6B was used to record the impulse response of the sensor at various angles of acoustic incidence within a 2.4 m×3.0 m×2.4 m (l, w, h) Whisper Room. The panel used in this experiment was a 3 mm thick acrylic sheet with a Young's Modulus of E=3.2 GPa, Poisson's ratio ν=0.35, density ρ=1180 kg m⁻³, and horizontal and vertical dimensions (Lₓ, L_{y})=(36 cm, 26 cm), respectively. The panel was mounted on a rotary table, allowing for measurements at 37 discrete angles of acoustic incidence in 5° increments, spanning from θ=−90° to θ=+90° in the azimuthal plane in front of the panel.

A single PCB Piezotronics U352C66 accelerometer was affixed to the panel, positioned 8 cm from the panel's edge along the x dimension and centered in the y dimension [34]. This sensor placement was selected to align with the antinodal regions of many low-order bending modes. A KEF LS50 loudspeaker, placed 1 m in front of the panel's center, was used to generate an excitation signal for measuring the impulse response of each sensor at each angle of acoustic incidence. The impulse responses were recorded using MAT-LAB's impulse response measurer app. For each incident angle, two maximum length sequence (MLS) excitations, each with a two second duration, were used to capture the panel's response. These impulse responses were then utilized to infer the responses of virtual sensors and compute the beamforming frequency-domain weights for each frequency of interest and angle of incidence.

Once the filters were calculated, they were applied to the real and virtual sensor array and the two experiments described in Sect. III-A were carried out. For these evaluations, a matched pair of KEF LS50 loudspeakers were used to reproduce the target speech and interfering speech.

### Virtual Sensors

A white noise burst was generated and convolved with the impulse response (IR) of the single structural sensor affixed to the panel. The frequency response of the convolved signal was computed using the Fast Fourier Transform (FFT), extracting both the magnitude and phase to represent the panel's response across frequencies. Virtual sensor responses were simulated by applying singular value decomposition (SVD) to the measured response matrix. This allowed for the estimation of directional responses for additional virtual sensors, inferred from the single recorded signal. The real sensor response and the simulated virtual responses were combined and filtered using frequency-domain weights calculated for a target beam pattern as described herein. This approach simulates multiple sensor responses based on a single recorded signal.

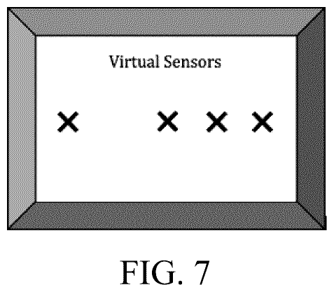

The virtual sensor positions were computed as locations evenly spaced along the x-axis, centered along the y-axis, with a uniform spacing of 6 cm between each virtual sensor and between virtual sensors neighboring the real sensor as seen in FIG. 7.

### Polar Responses

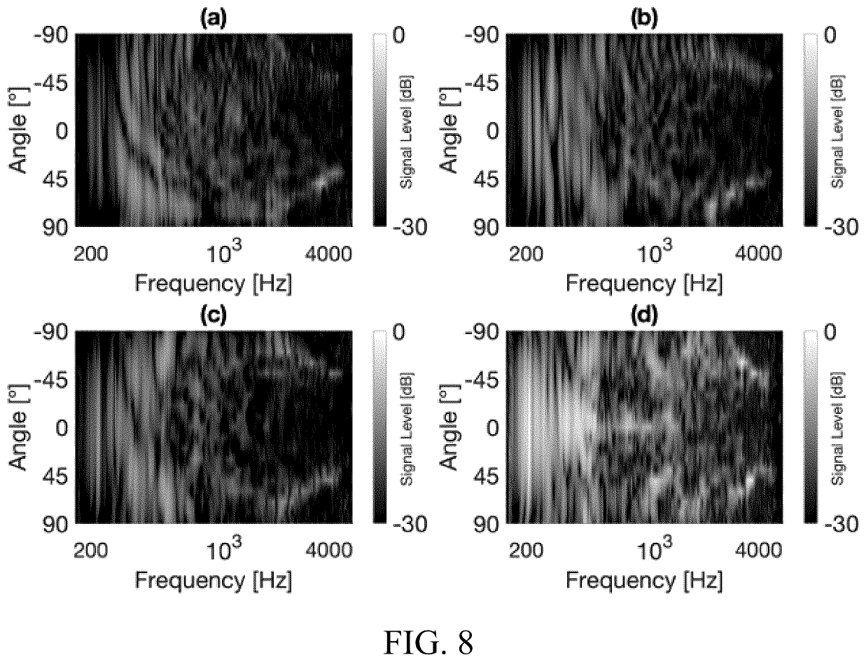

The polar responses for the individual, unfiltered sensors along with the resulting polar response when all of the unfiltered sensors are summed can be found in FIG. 8. Each polar response exhibits similar behavior, where the low-frequency response is dominated by individual modes, and the high-frequency response reflects the superposition of many simultaneously excited resonant modes.

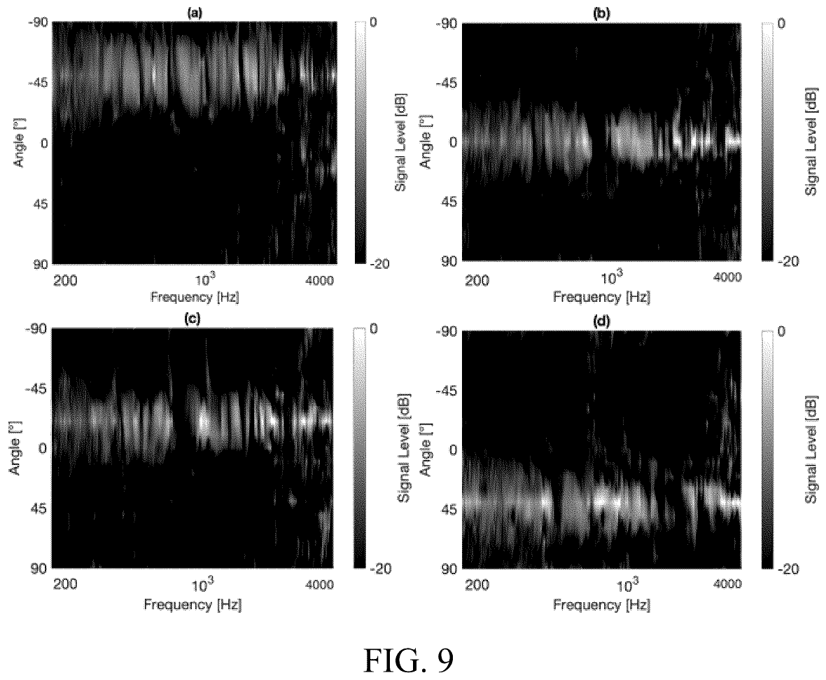

FIG. 9 depicts the polar response versus frequency of the filtered system for various target angles. Each plot shows a target polar pattern at specified angles, with significant suppression of the off-axis response. These results demonstrate the efficacy of applying optimized frequency-domain weights to sensors affixed to a panel in order to achieve a target polar pattern and off-axis reduction of up to 25 dB. The regions of minimal response within the target beam arise due to the truncation of small singular values during the SVD-based inversion process. In these directions, the system response is poorly conditioned, and direct inversion would require disproportionately large filter weights. To maintain stability and prevent excessive amplification, the SVD suppresses these components, resulting in low sensitivity where accurate control is not feasible. The measured polar pattern at 1500 Hz for each sensor configuration steered toward a 40° target is shown in FIG. 4.

### Directivity

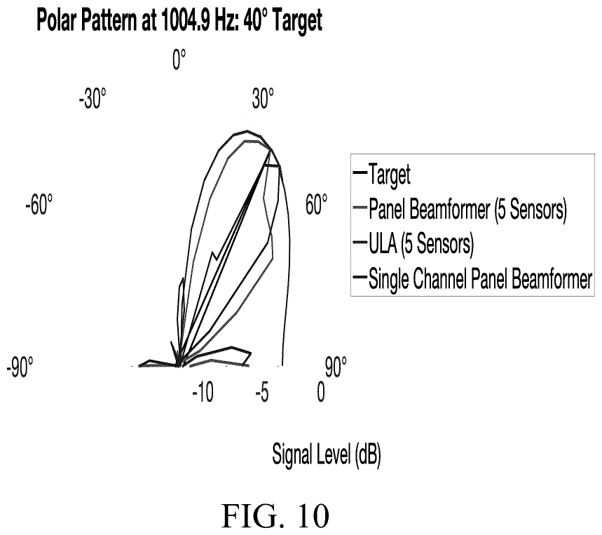

Using a single real sensor and four virtual sensors, the panel beamformer achieves a directivity above 6 dB across the entire audible frequency range, including low frequencies where ULAs tend to become nearly omnidirectional. This behavior is illustrated in FIG. 10, which presents the directivity vs. frequency for panel beamformers and ULAs with different sensor configurations and beam steering angles.

### Intelligibility

The system's performance in coping with interference in the form of off-axis interfering speech was evaluated using the dataset outlined herein. WER analysis was performed on recordings captured by both the filtered and unfiltered sensor arrays under identical conditions to measure the performance enhancement achieved by applying the optimized beamforming filters.

The results from Table 2 demonstrate a substantial increase in the intelligibility of the target speech signal in the presence of off-axis noise speech when applying the frequency-domain weights to the system. Specifically, the WER shows a reduction from 126.7% to 35% when the target speech is located at −30° and the off-axis noise speech is located at 30°. When the target speech is located at −10° and the off-axis noise speech is located far away at 90°, the WER decreases from 118.2% to 43.6% with the application of the optimized weights.

TABLE 2
Comparison of WER with and without optimized beamforming filters.
Target speech was played from the target angle with the corresponding
frequency-domain weights applied, while an off-axis babble
signal was played at another location.

| Target Speech | Noise | Unfiltered | Filtered |
|---|---|---|---|
| Location | Location | WER (%) | WER (%) |
| −30° | 30° | 126.7 | 35 |
| −10° | 90° | 118.2 | 19.4 |
| 50° | 40° | 235.4 | 43.6 |

| | | |
|---|---|---|
| Baseline (No Babble) | 4.8 | 6.1 |

The improvement in WER is also substantial when the origin angle of off-axis interfering speech is in close angular proximity to the source of the target speech. When the target speech is located at 50° and the off-axis interfering speech is located at 40°, the WER decreases from 235.4% to 43.6% with the application of the optimized weights.

While various embodiments have been described above, such disclosures have been presented by way of example only and are not limiting. Thus, the breadth and scope of the subject compositions and methods should not be limited by any of the above-described exemplary embodiments but should be defined only in accordance with the following claims and their equivalents.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives they intended unless the context specifically indicates the contrary.

What is claimed is:

1. A method of detecting sound by acoustic beamforming with structural sensors, comprising the steps of:
affixing one or more structural vibration or strain sensing elements to an elastic base surface, wherein bending vibrations of the elastic base surface are excited by incoming acoustic waves and the one or more structural vibration or strain sensing elements in turn output a signal corresponding to the motion of the base surface at the sensor location due to acoustic wave excitation;
determining a response of one or more structural vibration or strain sensing elements individually to acoustic waves at varying angles of incidence wherein the responses are obtained at frequencies within the audio bandwidth;
selecting a target polar pattern for the sensor array at each frequency, wherein the polar pattern governs the sensitivity of the signal recorded by the one or more structural vibration or strain sensing elements to waves depending on their angles of incidence, and wherein the amplitude of the signals combined from all sensors, or a subset of sensors, is highest to waves incident at a desired angle of incidence, and minimized at all other angles;
computing a filter to be applied to each one or more structural vibration or strain sensing element signal and/or one or more virtual structural vibration or strain sensing element signal, wherein the filter governs the magnitude and phase of each signal;
generating coefficients for each filter such that the difference between the target polar pattern and the polar pattern generated by combining each filtered sensor signal is minimized; and
receiving a beamformed audio signal from the one or more structural vibration or strain sensing elements by summing the filtered signals recorded by each vibration of one or more structural vibration or strain sensing elements or inferred via one or more virtual structural vibration or strain sensing elements.

2. The method of claim 1, wherein the one or more structural vibration or strain sensing elements are vibration sensors.

3. The method of claim 1, wherein the one or more structural vibration or strain sensing elements are strain sensors.

4. The method of claim 1, wherein the individual responses of the one or more structural vibration or strain sensing elements is determined by empirical measurements.

5. The method of claim 1, wherein the individual responses of the one or more structural vibration or strain sensing elements is inferred as a “virtual sensor” from a single sensor signal using a priori measurements of the system transfer functions.

6. The method of claim 1, wherein the individual responses of the one or more structural vibration or strain sensing elements is determined using an analytical model.

7. The method of claim 6, wherein the analytical model is selected from the group comprising FEM, lumped element, equivalent circuit models, generic differential equation system solver, artificial intelligence-generated model, and deep neural network.

8. The method of claim 1, wherein the minimizing technique is singular value decomposition.

9. The method of claim 1, wherein the minimization techniques are one or more global and/or local techniques comprising pattern search, particle swarm, genetic algorithm, or other methods for minimizing an objective function, local schemes with minimization approaches, local schemes with least-squares approaches, and global schemes, wherein such global schemes comprise GlobalSearch, MultiStart, Surrogate Optimization, or Simulated Annealing.

10. The method of claim 1, wherein the structural vibration or strain sensing elements form a sensor array that is distributed on a display screen

11. The method of claim 1, wherein the structural vibration or strain sensing element signals are read in through a computer.

12. The method of claim 1, wherein the filters can be digital or analog

13. The method of claim 1, wherein the filter is designed to work within one or more sub-bands of the audio frequency band.

14. The method of claim 1, wherein the one or more of the structural vibration or strain sensing elements are transparent to a visible part of the electromagnetic spectrum.

15. The method of claim 1, wherein the structural vibration or strain sensing elements are located around the perimeter of the panel.

16. The method of claim 1, wherein the structural vibration or strain sensing elements are positioned to couple to a prescribed set of bending modes of the base surface.

17. The method of claim 1, wherein the beamformed signal is used for sound enhancement.

18. The method of claim 1, wherein the beamformed signal is used for source localization/tracking.

19. The method of claim 1, wherein the beamformed signal is used for noise reduction.

20. A system of detecting sound by acoustic beamforming with structural sensors, comprising:
an elastic base surface;
one or more structural vibration or strain sensing elements affixed to the elastic base surface, wherein bending vibrations of the elastic base surface are excited by incoming acoustic waves and the one or more structural vibration or strain sensing elements in turn output a signal corresponding to the motion of the base surface at the sensor location due to acoustic wave excitation;
a processor and a memory having instructions stored thereon, wherein execution of the instructions by the processor computes a filter to be applied to each one or more structural vibration or strain sensing element signal or virtual one or more structural vibration or strain sensing element signal, wherein the filter governs the magnitude and phase of each signal;
a receiver, wherein a beamformed audio signal is received from the one or more structural vibration or strain sensing elements by summing the filtered signals recorded by each vibration one or more structural vibration or strain sensing element or inferred via one or more virtual structural vibration or strain sensing elements, wherein the beamformed audio signal has been determined according to the method of claim 1.
